(19) United States
(12) Patent Application Publication
(10) Pub. No.: US 2026/0228193 A1
(43) Pub. Date: Aug. 6, 2026

(54) SOURCE VALIDATION DATA VISUALIZER

(71) Applicant: Walmart Apollo, LLC, Bentonville, AR (US)

(72) Inventors: Candy Avila, San Francisco, CA (US); Heidi Tsoi ying Ng, Fremont, CA (US); Prachi Abhay Patki, Bentonville, AR (US)

(21) Appl. No.: 19/042,861

(22) Filed: Jan. 31, 2025

(51) Int. Cl. G06F 16/215; G06F 16/26

(52) U.S. Cl. CPC G06F 16/215; G06F 16/26

(57) ABSTRACT

Examples provide validation and visualization of data sources relied upon by a generative (GEN) artificial intelligence (AI) machine learning (ML) model when generating a response to a user query. The data sources are analyzed to determine whether each source is a valid source based on a degree of reliability of the source and relevance of the source to the query. A validation score and/or rank is generated for each source. An interactive user interface (UI) is generated which includes a query-response viewing pane for viewing the query and the response and an interactive source validation viewing pane for presenting the identified sources with the score and/or rank for each source. The interactive source validation pane can include summaries of the sources, links to relevant portions of the sources, collected sources data tables including selected portions of the sources, and text fields for user feedback used to retrain the model.

### BACKGROUND

As utilization of artificial intelligence (AI) increases, distrust can in AI-provided information can sometimes occur due to the possibility of AI hallucinations. An AI hallucination refers to a response generated by an ML model, such as a generative AI model, that contains erroneous or non-sensical information presented as fact. These hallucinations can sometimes occur due to incorrect assumptions made based on improper or invalid information sources utilized by ML models. This can result in user distrust in AI query responses and generation of responses containing potentially erroneous or misleading information.

### SUMMARY

Some embodiments provide a system for source validation and visualization. A generative artificial intelligence (Gen AI) machine learning (ML) model identifies a source of information relied upon to generate a response to a query. The query and the response are surfaced to a user via a query-response pane of an interactive user interface (UI) display. The Gen AI ML model performs a validation assessment on the source of information by the Gen AI ML model. The Gen AI ML model is trained using labeled training data to identify valid sources of information and invalid sources of information for response generation. An interactive source validation viewing pane is provided within the interactive UI display. The interactive source validation viewing pane and the query-response pane are visible within the interactive UI display via a UI device. The Gen AI ML model presents the result of the validation assessment, including an identification of the source of the information and a validity indicator indicating whether validation of the source is successful or unsuccessful.

Other embodiments provide a method for source validation and visualization. A source of information relied upon by a Gen AI ML model to generate a response to a query is identified. The query and the response are surfaced to a user via a query-response pane of an interactive UI display. A validation assessment is performed on the source of information by the Gen AI ML model. The Gen AI ML model is trained using labeled training data to identify valid sources of information and invalid sources of information for response generation. The result of the validation assessment is generated. The result indicates successful validation of the source of the information or a failure to validate the source of the information. An interactive source validation pane is generated within the interactive UI display. The interactive source validation pane and the query-response pane are visible within the interactive UI display via a UI device. The results of the validation assessment is presented within the interactive source validation pane. The result includes an identification of the source of the information, a validity indicator, and an interactive option to obtain additional information associated with the source. The validity indicator indicates successful validation of the source of the information or failure to validate the source of the information.

Still other embodiments provide a computer storage devices having computer-executable instructions stored thereon, which, upon execution by a computer, cause the computer to perform operations comprising: identifying a plurality of data sources of information relied upon by a trained Gen AI ML model to generate a response to a query; performing a validation assessment on the plurality of the sources of the information by the Gen AI ML model; generating a result of the validation assessment on the plurality of the sources of the information; generating an interactive source validation pane within the interactive UI display, wherein the interactive source validation pane and the query-response pane are visible within the interactive UI display via a UI device; and presenting a list of the sources in the plurality of data sources of the information relied upon by the Gen AI ML model to generate the response to the query with the result of the validation assessment, wherein the result comprises a validation score indicating whether each source is validated or failed to be validated by the Gen AI ML model.

This Summary is provided to introduce a selection of concepts in a simplified form that are further described below in the Detailed Description. This Summary is not intended to identify key features or essential features of the claimed matter, nor is it intended to be used as an aid in determining the scope of the claimed subject matter.

### BRIEF DESCRIPTION OF THE DRAWINGS

FIG. 1 is an exemplary block diagram illustrating a system for visualization of validity results associated with sources of information utilized by generative artificial intelligence (Gen AI) machine learning (ML) models.

FIG. 2 is an exemplary block diagram illustrating a data visualizer component for validation and visualization of data source validation results.

FIG. 3 is an exemplary block diagram illustrating a data visualization user interface (UI) display for presenting a query-response pane and an interactive source validation pane for visualizing data source validation results.

FIG. 4 is an exemplary flow chart illustrating operation of the computing device to visualize data source validation.

FIG. 5 is an exemplary flow chart illustrating operation of the computing device to generate interactive content associated with data sources relied upon by a Gen AI model for generating query responses.

FIG. 6 is an exemplary flow chart illustrating operation of the computing device to obtain a response and identify sources used to generate the response.

FIG. 7 is an exemplary screenshot diagram illustrating a screenshot of a data visualization UI display.

FIG. 8 is an exemplary diagram illustrating a screenshot of an interactive source validation pane enabling user selection of portions of sources for creation of a collected sources data table.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some embodiments, . . . ” For brevity and clarity of presentation, this implied leading clause is not repeated ad nauseum.

Referring to the figures, examples of the disclosure enable data source validation and visualization of validation results. In some embodiments, a data visualizer performs a validation assessment on sources of information used by a generative artificial intelligence (Gen AI) machine learning (ML) model to generate a response to a query, such as, but not limited to, a large language model (LLM) chatbot or other query response system responding to user queries. The data visualizer enables an interactive viewing pane for providing validation results to users. This enables improved user efficiency via UI interaction and increased user interaction performance.

Other embodiments provide validation results within an interactive source validation pane surfaced simultaneously with a query response such that a user can view a response to a query and also view validation results identifying the sources of information used to generate the results, a validity indicator identifying valid sources and invalid sources, as well as providing interactive options enabling a user to request additional information associated with the sources, such as a summary of the sources, links to relevant portions of the sources, validity scores, source rankings, options to consolidate portions of two or more sources, and/or an option for the user to provide real-time feedback associated with the validity results. This improves user confidence in the responses generated by the Gen AI ML model and reduces errors by identifying invalid sources or sources which may not be as dependable as other sources.

Aspects of the disclosure further enable improved chatbot response generation by validating sources of information used by the Gen AI ML model. The Gen AI ML model is re-trained and/or fine-tuned using feedback associated with the validity results generated by the model. Thus, if the sources of information being used fail to achieve a user-desired level of validation, the feedback can be used to re-train the model to identify appropriate sources of information more accurately for use in generating responses to user queries. In this manner, the system becomes more accurate over time. This further reduces errors occurring in the response data generated by the trained Gen AI ML model.

The computing device operates in an unconventional manner by identifying and validating sources of information used for generating each response generated by a Gen AI ML model, such as, but not limited to, a chatbot. The data visualizer generates interactive source validation data which is presented to a user in a separate interactive source validation pane enabling the user to view validation results simultaneously with the response in a separate viewing pane for improved efficiency and reduction of system resource usage which would be consumed by navigating away from the response page to view source validation information in a separate page or other location. This improves the speed with which a user can obtain validation results. It also eliminates the need for the user to navigate away from the Gen AI ML model query response page as the validation results can be viewed at the same time as the query response in a single data visualization UI display.

In this manner, the computing device is used in an unconventional way, and allows reduced system resource usage by presenting validation results simultaneously with query response data in a separate viewing pane and permitting the user to interact with the validation result data in the separate viewing pane for improved user interaction via the UI while also reducing time and resources which would otherwise be consume in navigating away from a current page to a different page to view the data sources. This further improves the functioning of the underlying computing device.

The system improves user confidence in Gen AI ML model responses as well as improves the reliability of the responses by ensuring all sources are verified and/or that only validated sources are being used. Users can validate the data sources of their AI and use Gen AI in their daily tasks without improved confidence in the reliability and validity of the Gen AI responses. This increases usage, saving time and improves workflow efficiency.

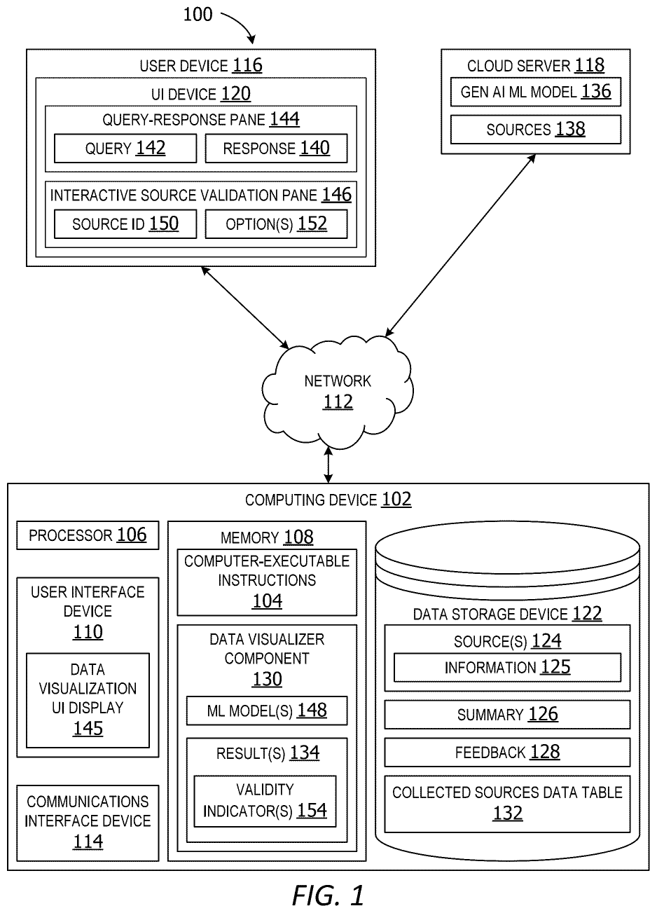

Referring again to FIG. 1, an exemplary block diagram illustrates a system 100 for visualization of validity results associated with sources of information utilized by generative artificial intelligence (Gen AI) machine learning (ML) models. In the example of FIG. 1, the computing device 102 represents any device executing computer-executable instructions 104 (e.g., as application programs, operating system functionality, or both) to implement the operations and functionality associated with the computing device 102. The computing device 102, in some embodiments includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some embodiments, the computing device 102 has at least one processor 106 and a memory 108. The computing device 102, in other embodiments includes a user interface device 110.

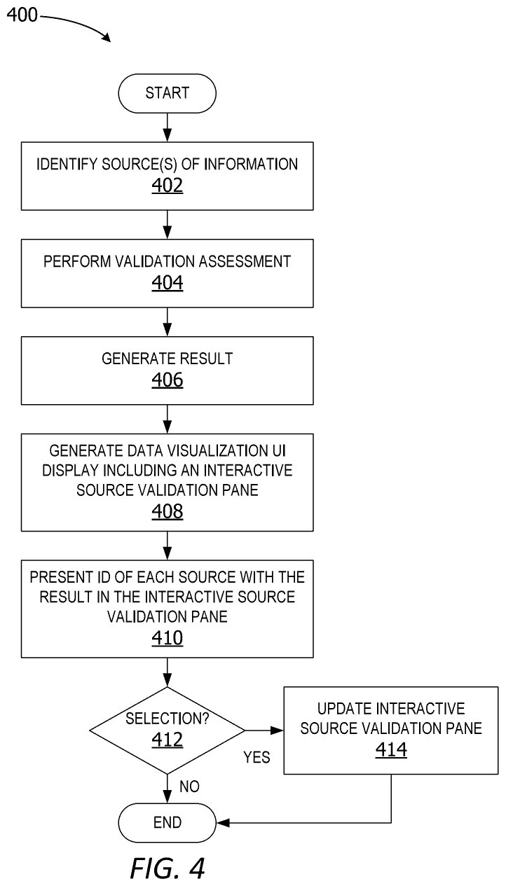

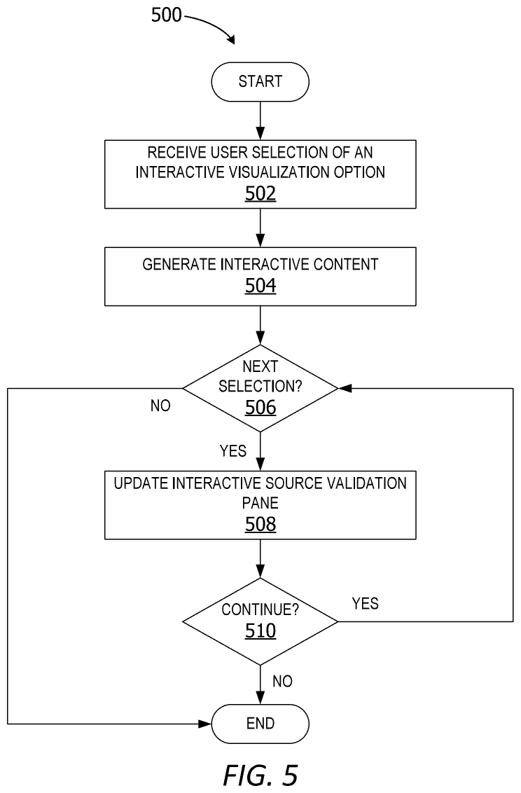

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some embodiments, the processor 106 is programmed to execute instructions such as those illustrated in the figures (e.g., FIG. 4 and FIG. 5).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other embodiments, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other embodiments, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other embodiments, the network 112 is a local or private LAN.

In some embodiments, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116 and/or a cloud server 118, can occur using any protocol or mechanism over any wired or wireless connection. In some embodiments, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface (UI) device 120.

The cloud server 118 is a logical server providing services to the computing device 102 or other clients, such as, but not limited to, the user device 120. The cloud server 118 is hosted and/or delivered via the network 112. In some non-limiting examples, the cloud server 118 is associated with one or more physical servers in one or more data centers. In other embodiments, the cloud server 118 is associated with a distributed network of servers.

The system 100 can optionally include a data storage device 122 for storing data, such as, but not limited to one or more source(s) 124 of information 125 utilized by a data visualizer component 130 to generate source validation result(s) 134, a summary 126 of one or more of the source(s) 124, feedback 128 associated with the result(s) 134, and/or a collected sources data table 132 consolidating portions of one or more of the source(s) 124.

The data storage device 122 can include one or more different types of data storage devices, such as, for example, one or more rotating disks drives, one or more solid state drives (SSDs), and/or any other type of data storage device. The data storage device 122 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other embodiments, the data storage device 122 includes a database.

The data storage device 122 in this example is included within the computing device 102, attached to the computing device, plugged into the computing device, or otherwise associated with the computing device 102. In other embodiments, the data storage device 122 includes a remote data storage accessed by the computing device via the network 112, such as a remote data storage device, a data storage in a remote data center, or a cloud storage.

The memory 108 in some embodiments stores one or more computer-executable components, such as, but not limited to, the data visualizer component 130. The data visualizer component 130, when executed by the processor 106 of the computing device 102, identifies the source(s) 124 of information 125 relied upon by a generative artificial intelligence (Gen AI) machine learning (ML) model 136 to generate a response 140 to a query 142. In this example, a user enters the query 142 via a text field in a query-response pane 144 of a data visualization UI display 145 presented to the user via a user interface, such as, but not limited to, the UI device 120 and/or the user interface device 110 in FIG. 1.

In this example, the query 142 and the response 140 are surfaced to a user via a query-response pane presented with an interactive source validation pane 146. The interactive source validation pane 146, in some embodiments is presented below the query-response pane 144 as an interactive bottom sheet. However, the embodiments are not limited to a data visualization UI display 145 having the query-response pane 144 positioned directly above the interactive source validation pane 146. In other embodiments, the interactive source validation pane 146 is positioned above the query-response pane 144. In still other embodiments, the interactive source validation pane 146 is located to a right side or a left side of the query-response pane 144.

The source(s) 124 utilized to generate the response 140 are identified from a plurality of sources 138 of information available from one or more sources. The plurality of sources 138 can include internal data sources as well as external data sources. The sources 138, in this example, are located on a remote cloud server 118 and accessed via the network 112. However, in other embodiments, one or more of the sources 138 are located on the local data storage device 122.

In this example, a remote Gen AI ML model 136 identifies the source(s) 124 utilized to generate the response 140 to the query 142. The query 142 is any type of query, such as, but not limited to, a text query, a natural language (spoken) query, etc. However, in other embodiments, one or more ML model(s) 148 of the data visualizer component 130 identifies the source(s) 124. A ML model in the one or more ML model(s) 148 is a pretrained model for generating responses to queries and/or validating sources of information used to generate a specific response to a specific query. The ML model(s) 148 can include any type of trained ML model, such as, but not limited to, a large language model (LLM) and/or a Gen AI ML model.

A source is identified by a source identifier (ID) 150. The source ID 150 can include any type of identifier, such as, but not limited to, a name, location address on a data storage device, an ID number, an international standard book number (ISBN), serial number, barcode number, or any other type of identifier for identifying a source of information. The source ID 150 can optionally also include bibliographic information, such as a name of an author, publisher, date of publication, etc.

In some embodiments, the data visualizer component 130 performs a validation assessment on one or more of the source(s) 124 of information 125. The validation assessment is performed by one or more of the ML model(s) 148 and/or the Gen AI ML model 136. The Gen AI ML model 136 and/or one or more of the ML model(s) 148 are trained using labeled training data to identify valid sources of information and invalid sources of information for response generation. In some embodiments, the validity of a source is determined based on semantic similarity of the contents of the source to one or more words or phrases in the query 142. In other embodiments, validity is determined based on the source type, source location, or other information associated with the source. For example, an internal source is more reliable and therefore more valid than an external source. An official news source is more dependable and valid than a non-official news source.

The data visualizer component 130 generates the interactive source validation pane 146 within the interactive UI display. The interactive source validation pane 146 and the query-response pane 144, in this example, are both visible within the interactive UI display 145 via a UI device, such as the UI device 120 and/or the user interface device 110.

In some embodiments, the result(s) 134 of the validation assessment are surfaced to a user within the interactive source validation pane 146. The result(s) 134 include the source ID 150, one or more validity indicator(s) 154, and one or more interactive option(s) 152 to obtain additional information associated with the source(s) 124. A validity indicator indicates successful validation of the source of the information or failure to validate the source of the information. A validity indicator can include a color, highlighting, an icon, a check mark, an “x” mark, an underlining, a strike through, an arrow, an emoji, or any other type of indicator for indicating a successful validation or a failed validation of a source.

In some embodiments, the interactive option(s) 152 includes a summary request option. The summary request option is presented within the interactive source validation pane 146 associated with a source for which a summarization is available or can be generated. If a user selects the summarization option, the data visualizer component 130 generates a summary or retrieves the summary 126 from the data storage device 122. The summary is presented to the user within the interactive source validation pane 146. In other words, the contents of the interactive source validation pane are updated to include the summary 126.

In this example, the summary 126 is not provided unless a user selects a summarization option, such as be clicking on a button or icon. However, in other embodiments, a summary of each source in the one or more source(s) 124 is automatically generated and provided within the interactive source validation pane 146 without waiting for a user to request the summary. In still other embodiments, a summary icon is presented with each source ID 150. If the user clicks on the summary icon for a specific source ID, the summary for the source corresponding to the source ID is displayed within the interactive source validation pane 146. If the user clicks on multiple summary icons for multiple sources, the data visualizer component 130 presents a summary for each source associated with a selected summary icon.

The interaction option(s) 152, in other embodiments, includes an option to provide feedback. If a user selects the feedback option, a feedback text field is presented within the interactive source validation pane 146. The user can optionally enter feedback via the text field or provide verbal feedback via a natural language input device, such as a speaker. In this example, the feedback text field is provided after a user selects the feedback option. In other embodiments, the user is prompted to enter feedback via a prompt which is surfaced to the user within the interactive source validation pane 146. In still other embodiments, the interactive source validation pane 146 always includes a feedback text field within the interactive source validation viewing pane which enables a user to provide feedback at any time via the text field. The feedback 128 provided by users is optionally stored in a data storage, such as, but not limited to, the data storage device 122 and/or a cloud storage.

In other embodiments, the interaction option(s) 152 includes a link to a relevant portion of the source of the information. The data visualizer component 130 retrieves the relevant portion of the source of the information in response to user selection of the link. The relevant portion of the source of the information is displayed within the interactive source validation pane 146. In other embodiments, the link is a link to the entire source, such as a data table. If a user clicks or otherwise selects the link, the entire contents of the source associated with the link is retrieved and displayed or otherwise made available for viewing by the user within the interactive source validation pane 146.

In still other embodiments, the interactive option(s) 152 includes a consolidation of sources option. The data visualizer component 130 receives one or more portions of one or more of the source(s) 124 selected by a user. The data visualizer component 130 consolidates or collects the selected portions of the source(s) into a single collected sources data table 132. The collected sources data table 132 can be stored on a data storage device 122, displayed within the interactive source validation pane 146, and/or transmitted to another device via the network 112, such as, but not limited to, the cloud server 118.

The result(s) 134, in other embodiments, includes a rank and/or a score associated with each source in the one or more source(s) 124. A rank indicates a level of reliability or trustworthiness of a given source relative to other sources in the plurality of data sources 138 and/or the source(s) 124 utilized by the data visualizer component 130 or the Gen AI ML model 136 to generate the response 140. A score is a metric for indicating a degree of validity of a given source. A score which exceeds a threshold minimum score is a valid source. A score which falls below the threshold is an invalid source or an unvalidated source. The score can be a percentage score, a score on a scale from zero to one, or any other type of score.

In this example, the response 140 to the query 142 is generated by the Gen AI ML model 136. The validation of the source(s) 124 is performed by the data visualizer component 130, including the one or more ML model(s) 148. However, in other embodiments, the same Gen AI ML model generates the response 140 and performs the validation assessment on the source(s) 124 used to generate the response 140.

Thus, in some embodiments, the system 100 provides a validation layer to expose the sources of answers generated by a Gen AI ML model, such as, but not limited to, the one or more ML model(s) 148 and/or the Gen AI ML model 136.

The data visualizer component 130 provides information regarding the sources utilized in generating a response to a user query and validates those sources uses a trained ML model. The ML model(s) 148 are trained to validate sources using labeled training data and user feedback.

In some embodiments, the data visualizer component 130 ML model(s) 148 use categories and/or keywords associated with a query to determine whether the data sources used to generate the response were appropriate and reliable sources from which to draw data used to formulate the response. By showing and validating the sources for Gen AI ML model in the interactive source validation pane (interactive bottom sheet), the system 100 is able to expose the source of the answers given, adding a layer of verification. Data sources are ranked in accordance with the reliability/level of validation of the source. For example, if a user asks about out-of-stock items, a data table associated with out-of-stock items from an inventory database that is internal to the system is ranked as being very reliable as the source is closely related to the initial query. The data visualizer component 130 with the data visualization enables creation of trust in users and improves the user ability to identify hallucinations and other errors made by incorrect assumptions in the training model.

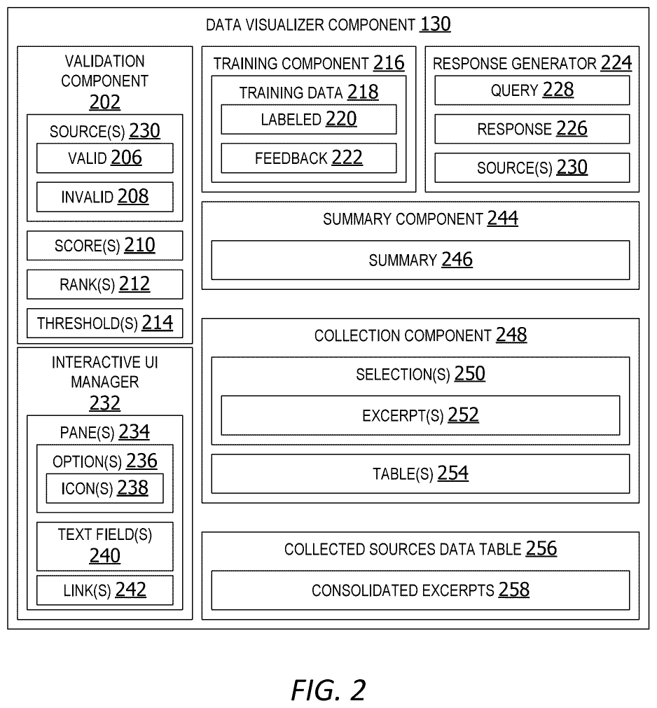

FIG. 2 is an exemplary block diagram illustrating a data visualizer component 130 for validation and visualization of data source validation results. In some embodiments, a validation component 202 performs a validation assessment to determine whether a source is valid 206 or invalid 208. In some embodiments, a list of sources presented in an interactive source validation pane is updated with an indicator that identifies valid and invalid sources. The validation component 202 optionally generates one or more score(s) 210 indicating a degree of validity or reliability for each source and/or one or more rank(s) 212 ranking each source relative to one or more other sources. In other embodiments, the rank(s) 212 identify a ranking of each source relative to one or more threshold(s) 214, such as a threshold score or a threshold level of reliability for a source of information.

In other embodiments, a training component 216 periodically re-trains a ML model generating the responses to queries and/or performing the validation assessment using training data 218. The training data 218 includes labeled 220 training data 218 and/or feedback 222 provided by one or more users. The re-training can occur at a predetermined event, such as at a regular time interval or at a predetermined date and time. In other embodiments, the retraining can occur when a user manually triggers the re-training.

A response generator 224 generates a response 226 to a query 228 using information from one or more source(s) 230. The one or more source(s) 230 include any type of source of information, such as, but not limited to, a data table. The source(s) 230 include a source of information, such as, but not limited to, the source(s) 124 in FIG. 1. In this example, the response generator 224 generates the response and a validation component validates the source(s) 230. However, in other embodiments, the response generator 224 is not included within the data visualization component 130. Instead, the response is generated by a different component than the data visualization component.

In some embodiments, an interactive UI manager 232 manages one or more viewing pane(s) 234, such as, but not limited to, a query-response pane and/or an interactive source validation pane within a UI display. One or more of the pane(s) 234 includes one or more interactive option(s) 236 for obtaining additional information or customization of validation data, such as, but not limited to, the option(s) 152 in FIG. 1. In this example, each option is identified via one or more selectable icon(s) 238. An icon is a graphical representation of an option which can be selected, such as by clicking the icon. The icon can include letters, numbers, symbols, text, colors, or other graphical elements.

The pane(s) optionally include one or more link(s) 242 to one or more sources in the one or more source(s) 230 used by a Gen AI ML model to generate a response to a query. The link(s) 242 can include a link to an entire document or a link to a relevant portion or excerpt from a source. For example, a link can be selected to retrieve the full contents of a data table, or it can retrieve a row and/or a column of the table that was used to generate the response.

The pane(s) 234 optionally include one or more text field(s) 240, such as, but not limited to, a query text field, a response text field, a feedback text field, etc. In other embodiments, the pane(s) 234 include one or more links to a data source, such as, but not limited to, a link to a document on a webserver or a link to a data table in a database which was used to generate the response 226.

A summary component 244 is a component for generating a summary 246 of a portion of a source and/or retrieving a pre-generated summary of a source. The summary 246 can include a summary of an entire source (all contents of the source) or a summary of one or more portions of the source.

In other embodiments, a collection component 248 obtains selection(s) 250 of excerpt(s) from one or more data source(s) 230. The collection component 248 uses the excerpt(s) 252 to create one or more collected table(s) 254, such as, but not limited to, a collected sources data table 256. The collected sources data table 256 is a single data table or other document containing two or more consolidated excerpts 258 from two or more different sources consolidated together in a single document, table, or file for easy storing, viewing, etc.

Users often deal with large quantities of data or multiple data tables associated with sources used by a ML model to generate a response. It can be difficult for users to access various data sources, such as databases and tables. The collection component 248 enables a user to view, compare, and create custom data sets from multiple sources of information without engineering assistance.

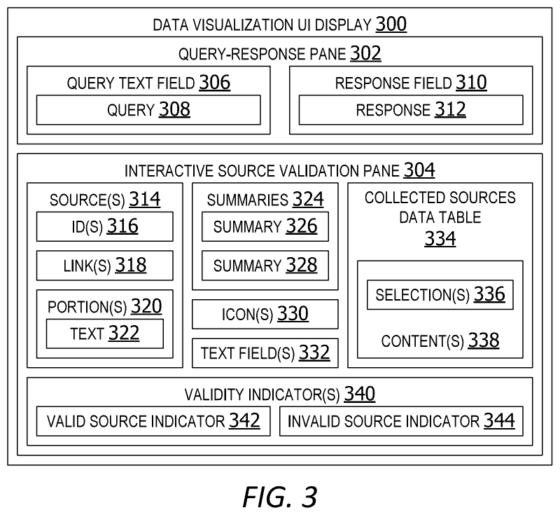

Turning now to FIG. 3, an exemplary block diagram illustrating a data visualization user interface (UI) display 300 for presenting a query-response pane and an interactive source validation pane for visualizing data source validation results is shown. The data visualization UI display 300 is a UI display including two or more viewing panes, such as, but not limited to, the data visualization UI display 145 in FIG. 1. In this example, the data visualization UI display 300 includes a query-response pane 302 and at least one interactive source validation pane 304.

The query-response pane 302 includes at least one query text field 306 in which a user can input a query 308. However, the embodiments are not limited to a query text field. In other embodiments, a user can input a query via a natural language (verbal) query input or any other input method.

The query-response pane 302, in this example, includes a response field 310 for outputting an ML model generated response 312. However, the embodiments are not limited to outputting a response in text format. In other embodiments, a response 312 can be output in an audible, natural language format via one or more speakers as well as any other method for outputting a query response.

The interactive source validation pane 304 is a viewing pane for presenting the results of a validation assessment performed on one or more source(s) 314. The results include one or more source ID(s) 316 for each of the source(s) 314 and/or one or more link(s) 318 to each of the source(s) 314. If a user selects one of the link(s) 318, the source associated with the link is retrieved and one or more portion(s) 320 of the text 322 of the source is displayed within the interactive source validation pane 304. The portion(s) 320 of the source can include the entire contents of the source or only a part (an excerpt) of the contents of the source.

The interactive source validation pane 304 optionally includes one or more summaries 324 of the source(s) 314, such as, but not limited to, a first summary 326 of a first source and a second summary 328 of a second source. One or more icon(s) 330 associated with one or more interactive options (functions) associated with the interactive source validation page is shown. In other embodiments, one or more text field(s) 332 enabling the user to provide feedback and/or request an interactive option is provided. For example, a user can type “provide a summary” in a text field to trigger the system to generate or retrieve a summary for one or more of the source(s) 314.

In other embodiments, the interactive source validation pane 304 includes a collected sources data table 334 including one or more selection(s) 336 from the content(s) 338 of two or more of the source(s) 314 consolidated together into a single file, document, or table for easy viewing and/or storage. This enables customized generation of source data tables for utilization by users.

In still other embodiments, one or more validity indicator(s) 340 are generated with the list of source(s) 314. A validity indicator can include a valid source indicator 342 indicating a source is validated or an invalid source indicator 344 indicating a source is invalid or failed to be validated during the validity assessment.

FIG. 4 is an exemplary flow chart illustrating operation of the computing device to visualize data source validation. The process 400 shown in FIG. 4 is performed by a data visualizer component, executing on a computing device, such as the computing device 102 or the user device 116 in FIG. 1.

The process begins by identifying one or more source(s) of information used to generate a response to a query at 402. The one or more source(s) include at least one source of information utilized by an ML model to generate the response, such as, but not limited to, the source(s) 124 in FIG. 1. A validation assessment is performed at 404. In some embodiments, the validation assessment is performed on each source in the one or more source(s) by a ML model, such as, but not limited to, the one or more ML model(s) 148 and/or the Gen AI ML model 136 in FIG. 1. A result of the validation assessment is generated at 406. The result is a validation result including an indication of whether each of the source(s) is validated or invalidated, such as, but not limited to, the result(s) 134. A data visualization UI display including an interactive source validation pane 408 is generated at 408. An ID of each source is presented with the result of the validation assessment in the interactive source validation pane at 410. A determination is made whether a user selects an interactive option at 412. If yes, the interactive source validation pane is updated at 414. The process terminates thereafter.

While the operations illustrated in FIG. 4 are performed by a computing device, aspects of the disclosure contemplate performance of the operations by other entities. In a non-limiting example, a cloud service performs one or more of the operations. In another embodiment, one or more computer-readable storage media storing computer-readable instructions may execute to cause at least one processor to implement the operations illustrated in FIG. 4.

FIG. 5 is an exemplary flow chart illustrating operation of the computing device to generate interactive content associated with data sources relied upon by a Gen AI model for generating query responses. The process 500 shown in FIG. 5 is performed by a data visualizer component, executing on a computing device, such as the computing device 102 or the user device 116 in FIG. 1.

The process begins by receiving user selection of an interactive visualization option at 502. An interactive visualization option is an option for obtaining additional information associated with the source(s) of information used to generate a response, such as, but not limited to, the option(s) 152 in FIG. 1.

Interactive content is generated at 504. The content is generated in response to the user selection. The content can include a summary of a source, an excerpt copied from the source, a consolidation of portions of multiple sources into a single collected data table, or any other additional content. A determination is made whether a next selection is received at 506. If not, the process terminates thereafter.

If a next selection is received at 506, the interactive source validation pane is updated at 508. The interactive source validation pane is a viewing pane, such as, but not limited to, the interactive source validation pane 146 in FIG. 1. A determination is made whether to continue at 510. If yes, the data visualizer component iteratively executes operations 506 through 510 until a determination is made to not continue. The process terminates thereafter.

While the operations illustrated in FIG. 5 are performed by a computing device, aspects of the disclosure contemplate performance of the operations by other entities. In a non-limiting example, a cloud service performs one or more of the operations. In another embodiment, one or more computer-readable storage media storing computer-readable instructions may execute to cause at least one processor to implement the operations illustrated in FIG. 5.

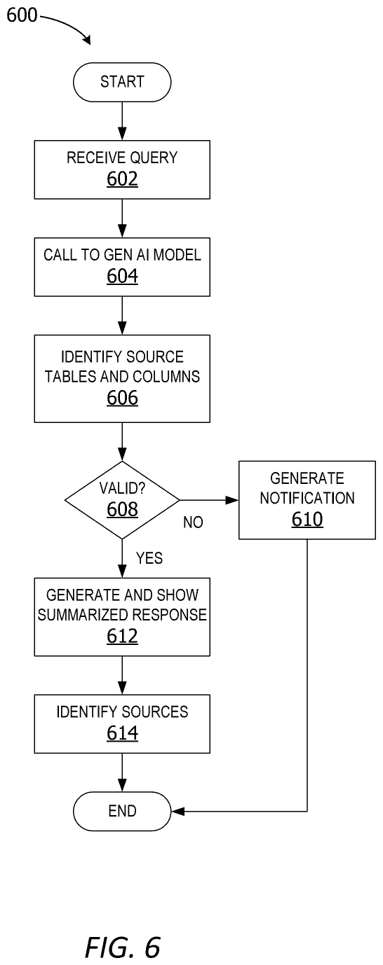

FIG. 6 is an exemplary flow chart illustrating operation of the computing device to obtain a response and identify sources used to generate the response. The process 600 shown in FIG. 6 is performed by a data visualizer component, executing on a computing device, such as the computing device 102 or the user device 116 in FIG. 1.

The process begins by receiving a query at 602. In some embodiments, the query is in the form of an AI prompt. A call is made to a Gen AI model with context to find sources at 604. In some embodiments, the Gen AI model identifies and gathers all ad hoc table columns. The system maps these adoptable columns to the source table. The system can directly relate the columns of the ad hoc tables to the source tables and directly fetch the data from it. This can include a direct map of the ad hoc tables to source table column, data transformation logic, and/or additional filters to sort and process the source information. The source tables and columns containing relevant information for responding to the query are identified and gathered at 606. Data validation is performed to determine if the sources are valid at 608. If not, a notification is generated at 610. The notification can include an alert sent to an engineering team and/or a notice sent to a user indicating that the sources could not be verified. If the sources are valid, a summarized response is generated and shown at 612. The sources used to generate the response are identified at 614. These sources can be shown in a viewing pane, such as an interactive source validation pane. The process terminates thereafter.

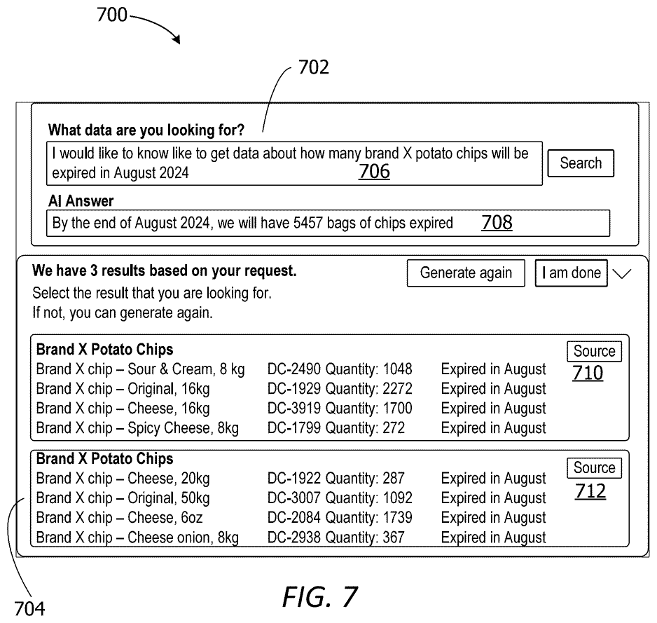

FIG. 7 is an exemplary diagram illustrating a screenshot of a data visualization UI display 700. The data visualization UI display 700 includes a query-response pane 702 and an interactive source validation pane 704. The query-response pane 702 includes a query field 706 for a user to enter a query and a response field 708 for the Gen AI model to output a response to the user. The interactive source validation pane 704 includes source-related validation data associated with a first source 710 and a second source 712.

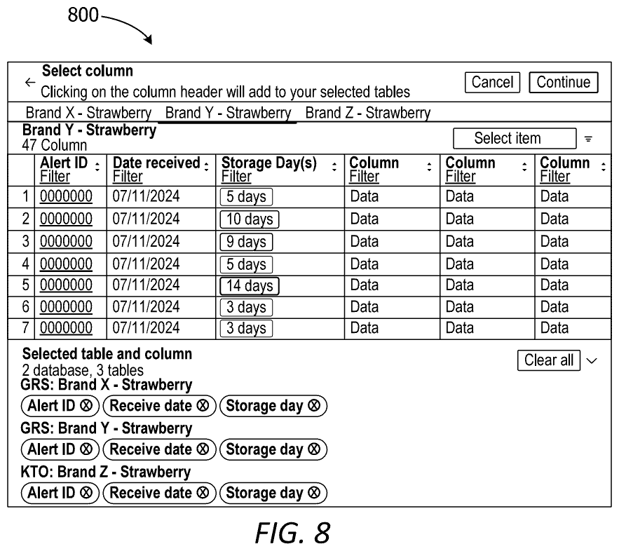

FIG. 8 is an exemplary diagram illustrating a screenshot of an interactive source validation pane 800 enabling user selection of portions of sources for creation of a collected sources data table. In this example, a user selects columns from two or more data tables to be combined together in a single collected sources data table for viewing, storage, or other use.

### Additional Examples

In some embodiments, the source data verification and visualization tool enables users to be able verify Gen AI ML model sources, access large quantities of source-related data, and create consolidated and customized source data tables without code, something that without this tool could not be done. Using known interactions and the interactive bottom sheet (interactive source validation pane) this structure query language (SQL) data visualizer can be used instead of SQL queries for a non-technical person to access and organize large amounts of data. SQL is a domain-specific language used to manage data, especially in a relational database management system. It is particularly useful in handling structured data, i.e., data incorporating relations among entities and variables. The impacts of the source data visualizer saves labor hours, reduces time spent manually verifying sources and curating source data, saving relevant portions of source data, increased productivity, and improved workflow without the dependence of a data scientist.

In some embodiments, the system enables users to gather and prepare data without knowing or needing to understand SQL. It visually lets them view their data sources, pick tables and columns within those databases, then create new source-related information tables from multiple databases in a way that is easy for anyone to use. As many users do not know how to write SQL queries, the source data visualizer allows them to create custom tables without writing a SQL query. This improved workflow saves them time and allows them to access their alerts and automated solutions within a shorter timeline.

The system, in some embodiments, ranks sources of data used to generate a response to a user query by a Gen AI. The ranking indicates the degree of reliability of the data source. If a data source is validated as an appropriate source (data table/database) from which to draw information used to formulate a response, the ranking is higher. If the source is less appropriate, the ranking is lower. An internal trusted database storing data closely related to the query is given a higher ranking. An external source (3^{rd} party) and/or a source storing data which is less closely related to the initial query is ranked lower.

Other embodiments provide additional information associated with the data sources used at a fine grained level. The user is provided with links to the data tables and/or databases from which data was collected for use in formulating a response to the user query. The system provides access to the data sources used to generate the responses. The Gen AI enables a user to select a source and drill down/directly access the original source and/or view a portion of the data from the original source which was used to generate the response. This enables the user to view ingested data.

The system, in some embodiments, provides an interactive source validation pane which is a viewing pane for exposing sources of information used to generate the responses to the user queries. The Interactive pane is separate from a pane having the query and response. The pane includes sources used, ranks/scores for the sources indicating reliability, links to data tables having the sources/information used, and optionally includes summaries of the information used. This permits users to provide feedback indicating whether the sources contained accurate information obtained from a reliable source, was the ranking/score helpful and accurate, etc. The feedback is used to retain/fine-tune the model.

The system validates Gen AI results through source databases used by the Gen AI ML model. By showing and validating the sources for Gen AI in the interactive source data validation pane, the system is able to expose the source of the answers given, adding a layer of verification. When paired with the interactive source validation pane UI component, it has the ability to contain large amounts of data to further improve validation. The source data validation enables users to be more confident that they are getting detailed information that is up to date and relevant to their business and/or specific queries. This significantly increases trust and adoption on Gen AI integrations. Moreover, customers using a Gen AI ML model to respond to customer queries, such as a chatbot, improves customer experience and enables completion of customer searches faster. This leads to an increased basket size for many customers as well as improving speed of checkout for greater convenience and improved user experience via the UI.

In an example scenario, if a user query asks how many strawberry product items out-of-stock across one or more stores are, the Gen AI ML model provides an answer. The source validation determines if the sources used to determine the number of strawberry products currently out-of-stock are reliable internal sources that provide current out-of-stock product information. In this example, an out-of-stock products data table would be considered highly relevant due to the similarity to the query and the type of data source which is an internal database with information associated with in-stock and out-of-stock products. This is a legitimate and reliable source of information. However, if the data source is an external database or a database containing information associated with product assortments or planogram data, these sources would be considered less reliable as they are unlikely to contain accurate and current out-of-stock product information for strawberries.

In another embodiment, if an ad hoc table is based on a weekly granularity and a source data table is on the daily granularity, for every row in the ad hoc table there are seven rows in the source tables representing the seven days of the week. The system identifies the columns during validation. The data validation includes checking whether all seven days in the table have non-null entries. This is a simple validation because a table with weekly data should include seven rows with non-null values which makes it a valid data point and the data table is validated.

In another embodiment, a user can select two or more columns from one or more source data tables. The selected columns are displayed in the interactive source validation pane. The user can view the collected columns in the viewing pane or choose to save the selected columns in a collected data table for later viewing or use automatically by the Gen AI ML model without requiring the user to perform any coding or other manual tasks associated with creating the new collected data table.

Alternatively, or in addition to the other embodiments described herein, examples include any combination of the following:
generate a summary of the source of the information in response to user selection of the interactive option;
present the summary of the source of the information within the interactive source validation pane;
generate a feedback text field within the interactive source validation pane;
store feedback in a data storage device for utilization in re-training the Gen AI ML model in response to receiving the feedback via the feedback text field;
retrieve the relevant portion of the source of the information in response to user selection of the link in response to a user selection of the link;
present the relevant portion of the source of the information within the interactive source validation pane;
wherein the interactive option comprises a consolidation of sources option, wherein the source of the information comprises a plurality of data sources;
receive a first selection of at least one portion of a first source in the plurality of data sources;
receive a second selection of at least one portion of a second source in the plurality of data sources;
generate a collected sources data table comprising the first selection of the at least one portion of the first source and the second selection of the at least one portion of the second source;
surface a contents of the collected sources data table within the interactive source validation pane;
generate a rank for each source in the plurality of data sources, the rank indicating a level of reliability of a given source relative to other sources in the plurality of data sources;
present an identification of each source in the plurality of data sources within the interactive source validation pane with the rank for each source;
generate a validation score for each source in the plurality of data sources, the validation score indicating whether a given source is valid or invalid;
present an identification of each source in the plurality of data sources within the interactive source validation pane with the score for each source;
identifying a source of information relied upon by a Gen AI ML model to generate a response to a query, wherein the query and the response are surfaced to a user via a query-response pane of an interactive UI display;
performing a validation assessment on the source of information by the Gen AI ML model, wherein the Gen AI ML model is trained using labeled training data to identify valid sources of information and invalid sources of information for response generation;
generating a result of the validation assessment by the Gen AI ML model, wherein the result indicates successful validation of the source of the information or a failure to validate the source of the information;
generating an interactive source validation pane within the interactive UI display, wherein the interactive source validation pane and the query-response pane are visible within the interactive UI display via a UI device;
presenting the result of the validation assessment within the interactive source validation pane, the result comprising an identification of the source of the information, a validity indicator, and an interactive option to obtain additional information associated with the source, wherein the validity indicator indicates successful validation of the source of the information or failure to validate the source of the information;
generating a summary of the source of the information in response to selection of the interactive option;
presenting the summary of the source of the information within the interactive source validation pane;
generating a feedback text field within the interactive source validation pane;
storing feedback received via the feedback text field in a data storage device;
re-training the Gen AI ML model using updated training data including the feedback;
wherein the interactive option comprises a link to a relevant portion of the source of the information;
retrieving at least a portion of the source of the information in response to user selection of the link;
surfacing the at least the portion of the source of the information within the interactive source validation pane in response to a user selection of the link;
receiving a first selection of at least one portion of a first source in the plurality of data sources;
receiving a second selection of at least one portion of a second source in the plurality of data sources;
generating a collected sources data table comprising the first selection of the at least one portion of the first source and the second selection of the at least one portion of the second source;
surfacing a contents of the collected sources data table within the interactive source validation pane;
generating a rank for each source in the plurality of data sources, the rank indicating a level of reliability of a given source relative to other sources in the plurality of data sources;
presenting an identification of each source in the plurality of data sources within the interactive source validation pane with the rank for each source;
generating a validation score for each source in the plurality of data sources, the validation score indicating whether a given source is valid or invalid;
presenting an identification of each source in the plurality of data sources within the interactive source validation pane with the score for each source.

At least a portion of the functionality of the various elements in FIG. 1, FIG. 2, and FIG. 3 can be performed by other elements in FIG. 1, FIG. 2, and FIG. 3, or an entity (e.g., processor 106, web service, server, application program, computing device, etc.) not shown in FIG. 1, FIG. 2, and FIG. 3. some embodiments, the operations illustrated in FIG. 4, FIG. 5, and FIG. 6 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other embodiments, a computer readable medium having instructions recorded thereon which when executed by a computer device cause the computer device to cooperate in performing a method of validating data sources, the method comprising identifying a source of information relied upon by a Gen AI ML model to generate a response to a query, wherein the query and the response are surfaced to a user via a query-response pane of a data visualization UI display; performing a validation assessment on the source of information by the Gen AI ML model; generating a result of the validation assessment by the Gen AI ML model, wherein the result indicates successful validation of the source of the information or a failure to validate the source of the information; generating an interactive source validation pane within the interactive UI display, wherein the interactive source validation pane and the query-response pane are visible within the interactive UI display via a UI device; and presenting an identification of the source of the information relied upon by the Gen AI ML model to generate the response to the query with the result of the validation assessment.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some embodiments, to a wireless local area network using high frequency radio signals for the transmission of data. The term “BLUETOOTH®” as used herein refers, in some embodiments, to a wireless technology standard for exchanging data over short distances using short wavelength radio transmission. The term “NFC” as used herein refers, in some embodiments, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other embodiments of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for source data validation and visualization. For example, the elements illustrated in FIG. 1, FIG. 2, and FIG. 3, such as when encoded to perform the operations illustrated in FIG. 4, FIG. 5, and FIG. 6, constitute exemplary means for generating a data visualization UI including a query-response pane and an interactive source validation pane, the query-response pane comprising a query and a response to the query generated by a Gen AI ML model; exemplary means for identifying a source of information utilized by the Gen AI ML model to generate the response to the query; exemplary means for validating the source of the information by the GEN AI ML model based on a semantic similarity of the source with the query and a degree of reliability associated with the source; and exemplary means for generating an interactive source data validation result for the source of the information within the interactive source validation pane, the interactive source data validation result comprising an identification of the source of the information, a validity indicator and an interactive option to request additional information associated with the source, wherein the validity indicator comprises a valid source indicator indicating successful validation of the source of the information or an invalid source indicator indicating a failure to validate the source of the information.

Other non-limiting examples provide one or more computer storage devices having a first computer-executable instructions stored thereon for providing a source data visualizer. When executed by a computer, the computer performs operations including identifying a plurality of data sources of information relied upon by a trained Gen AI ML model to generate a response to a query, wherein the query and the response are surfaced to a user via a query-response pane of a data visualization UI display; performing a validation assessment on the plurality of the sources of the information by the Gen AI ML model; generating a result of the validation assessment on the plurality of the sources of the information; generating an interactive source validation pane within the interactive UI display, wherein the interactive source validation pane and the query-response pane are visible within the interactive UI display via a UI device; and presenting a list of the sources in the plurality of data sources of the information relied upon by the Gen AI ML model to generate the response to the query with the result of the validation assessment, wherein the result comprises a validation score indicating whether each source is validated or failed to be validated by the Gen AI ML model.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of ”only one of or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1. A system comprising:
one or more processors; and
a computer-readable medium storing programming instructions that, upon execution by the one or more processors, cause the system to perform the following operations:
receiving, by a generative artificial intelligence (Gen AI) machine learning (ML) model, a query from a user, the query including a question about inventory items stocked across one or more stores;
identifying, by the Gen AI ML model, multiple sources containing information that is relevant to the query;
performing, by the Gen AI ML model, validation assessments on the sources to determine validity scores for the sources, wherein the validity scores are based at least partially on user feedback indicating whether the sources provided accurate information responsive to one or more previous queries;
generating, by the Gen AI ML model, a response to the query based on two or more of the sources having higher validity scores than the other sources;
simultaneously surfacing, via an interactive user interface (UI) display, the response to the query and an interactive source validation pane, wherein the interactive source validation pane displays links for retrieving relevant portions of the two or more sources; and
responsive to the user selecting at least one of the links, displaying at least one of the relevant portions of the two or more sources via the interactive source validation pane without displaying less relevant portions of the two or more sources.

2.-7. (canceled)

8. A method comprising:
receiving, by a generative artificial intelligence (Gen AI) machine learning (ML) model, a query from a user, the query including a question about inventory items stocked across one or more stores;
identifying, by the Gen AI ML model, multiple sources containing information that is relevant to the query;
performing, by the Gen AI ML model, validation assessments on the sources to determine validity scores for the sources, wherein the validity scores are based at least partially on user feedback indicating whether the sources provided accurate information responsive to one or more previous queries;
generating, by the Gen AI ML model, a response to the query based on two or more of the sources having higher validity scores than the other sources;
simultaneously surfacing, via an interactive user interface (UI) display, the response to the query and an interactive source validation pane, wherein the interactive source validation pane displays links for retrieving relevant portions of the two or more sources; and
responsive to the user selecting at least one of the links, displaying at least one of the relevant portions of the two or more sources via the interactive source validation pane without displaying less relevant portions of the two or more sources.

9.-14. (canceled)

15. One or more computer storage devices having programming instructions stored thereon, which, upon execution by one or more processors of a system, cause the system to perform the following operations:
receiving, by a generative artificial intelligence (Gen AI) machine learning (ML) model, a query from a user, the query including a question about inventory items stocked across one or more stores;
identifying, by the Gen AI ML model, multiple sources containing information that is relevant to the query;
performing, by the Gen AI ML model, validation assessments on the sources to determine validity scores for the sources, wherein the validity scores are based at least partially on user feedback indicating whether the sources provided accurate information responsive to one or more previous queries;
generating, by the Gen AI ML model, a response to the query based on two or more of the sources having higher validity scores than the other sources;
simultaneously surfacing, via an interactive user interface (UI) display, the response to the query and an interactive source validation pane, wherein the interactive source validation pane displays links for retrieving relevant portions of the two or more sources; and
responsive to the user selecting at least one of the links, displaying at least one of the relevant portions of the two or more sources via the interactive source validation pane without displaying less relevant portions of the two or more sources.

16.-20. (canceled)

21. The one or more computer storage devices of claim 15, wherein the programming instructions further cause the system to perform the following operations:
receiving, via the interactive source validation pane, real-time feedback from the user, the real-time feedback indicating whether the two or more sources achieved a user-desired level of validation; and
re-training the Gen AI ML model for source validation based on the real-time feedback.

22. The method of claim 8, further comprising:
receiving, via the interactive source validation pane, real-time feedback from the user, the real-time feedback indicating whether the two or more sources achieved a user-desired level of validation.

23. The method of claim 22, further comprising:
re-training the Gen AI ML model for source validation based on the real-time feedback.

24. The method of claim 23, wherein the real-time feedback is received via a feedback field on the interactive source validation pane.

25. The method of claim 23, wherein the real-time feedback is verbal feedback provided by the user after selecting a feedback prompt on the interactive source validation pane.

26. The method of claim 8, wherein the interactive source validation pane further displays summary request options for summarizing the two or more sources in their entireties.

27. The method of claim 26, further comprising:
responsive the user selecting one of the summary request options, displaying a summary of all content from a corresponding one of the two or more sources via the interactive source validation pane.

28. The method of claim 8, wherein the interactive source validation pane further displays a consolidation of sources option for consolidating relevant portions from the two or more sources into a single data table.

29. The method of claim 28, further comprising:
responsive the user selecting the consolidation of sources option, displaying the single data table via the interactive source validation pane.

30. The system of claim 1, wherein the programming instructions further cause the system to perform the following operation:
receiving, via the interactive source validation pane, real-time feedback from the user, the real-time feedback indicating whether the two or more sources achieved a user-desired level of validation.

31. The system of claim 30, wherein the programming instructions further cause the system to perform the following operation:
re-training the Gen AI ML model for source validation based on the real-time feedback.

32. The system of claim 31, wherein the real-time feedback is received via a feedback field on the interactive source validation pane.

33. The system of claim 32, wherein the real-time feedback is verbal feedback provided by the user after selecting a feedback prompt on the interactive source validation pane.

34. The system of claim 1, wherein the interactive source validation pane further displays summary request options for summarizing the two or more sources in their entireties.

35. The system of claim 34, wherein the programming instructions further causes the system to perform the following operation:
responsive the user selecting one of the summary request options, displaying a summary of all content from a corresponding one of the two or more sources via the interactive source validation pane.

36. The system of claim 1, wherein the interactive source validation pane further displays a consolidation of sources option for consolidating relevant portions from the two or more sources into a single data table.

37. The system of claim 36, wherein the programming instructions further causes the system to perform the following operation:
responsive the user selecting the consolidation of sources option, displaying the single data table via the interactive source validation pane.
